(19) United States
(12) Patent Application Publication
(10) Pub. No.: US 2020/0247257 A1
(43) Pub. Date: Aug. 6, 2020

(54) INTELLIGENT POWER WIRELESS CHARGING SYSTEM FOR ELECTRIC WHEELCHAIRS, ROBOTIC ARM AND RANGING SENSOR THEREOF

(71) Applicant: Menriyan Wireless High Power Technology (HK) Limited, Hong Kong (HK)

(72) Inventor: Lam Wing Ming, Hong Kong (HK)

(73) Assignee: Menriyan Wireless High Power Technology (HK) Limited, Hong Kong (HK)

(21) Appl. No.: 16/564,289

(22) Filed: Sep. 9, 2019

Related U.S. Application Data
(63) Continuation-in-part of application No. 16/264,690, filed on Feb. 1, 2019.

(51) Int. Cl. B60L 53/38; H02J 7/02; H02J 50/80; H02J 50/90; B60L 53/12; B60L 53/66; G01S 17/42

(52) U.S. Cl. CPC B60L 53/38; H02J 7/025; H02J 50/80; H02J 50/90; A61G 5/04; B60L 53/12; B60L 53/66; G01S 17/42; B60L 2200/34; H02J 7/027

(57) ABSTRACT

An intelligent power wireless charging system for electric wheelchairs, comprises: a wireless charging transmitter, the wireless charging transmitter has a transmitter and a robotic arm with transmitter pad; a wireless charging receiver installed in the electric wheelchair; when the electric wheelchair is driven to the wireless charging transmitter within a certain area, the wireless charging transmitter receives the signal from the wireless charging receiver, a ranging sensor detects the position of the electric wheelchair, a laser sensor emits reference lines for guiding the electric wheelchair is parked within the predefined charging position; the robotic arm is activated and carries the transmitter pad from the standby position to move to the predefined charging position; the ranging sensor is activated and detects the position of the electric wheelchair, the robotic arm automatically find the wireless charging receiver to charge; when the charging is completed, the robotic arm automatically returns to the standby position.

### CROSS-REFERENCE TO RELATED APPLICATIONS

This is a Continuation-in-Part of U.S. patent application Ser. No. 16/264,690, filed Feb. 1, 2019, the contents of which are incorporated by reference herein in their entirety.

### FIELD OF THE INVENTION

The present invention generally relates to the technical field of power charging, and more particularly to an intelligent power wireless charging system for electric wheelchairs, robotic arm and ranging sensor thereof.

### BACKGROUND OF THE INVENTION

Elderly people or persons with physical disability may have limited mobility due to old age and other factors requiring them to use devices such as electric wheelchairs to maneuver around areas. These electric wheelchairs need to be charged periodically to have enough power to function throughout the day. Charging the electric wheelchairs requires the person to make a number of physical movements. However, this is a difficult task for people with limited mobility.

A U.S. Pat. No. 5,617,003 disclosed a method and apparatus for charging a battery of an electric vehicle. The method and apparatus of charging a battery of an electric vehicle through inductive coupling between a primary inductive device having a core and a primary coil connected to a power source and a secondary inductive device having a core and a secondary coil connected to the battery are disclosed. The primary inductive device is provided on a movable arm of a ground charger unit and the secondary inductive device is mounted on the bottom of the vehicle adjacent to its rear end. The power source supplies the primary coil selectively a charging current and a check current. When the check current is supplied to the primary coil, an electromotive force is induced in the secondary coil which varies with a change of the relative position between the primary and secondary inductive devices. The variation in the induced electromotive force causes a change of the check current flowing in the primary coil. The position where the primary inductive device should be placed with respect to the secondary inductive device just before coupling thereof is determined on the basis of the change of the check current which is monitored while moving the primary inductive device relative to the secondary inductive device.

Apparently, in order to connect the charger and the handle with the receiver to each other by magnetic attraction, the handle with the receiver must be brought very close to the charger. For people with limited mobility, it is still very inconvenient.

Another U.S. Pat. No. 9,739,844B2 disclosed a guidance and alignment systems for wireless charging to assist in aligning the wireless charging transmitter and receiver inductive power transfer (IPT) couplers. These systems guide positioning and alignment to provide sufficient coupling between the wireless charging transmitter and receiver IPT couplers. Exemplary systems provide a magnetic field sensor, magnetic field generator, and magnetic vectoring to determine a position of an electric vehicle or a wireless charging base. In a magnetic vectoring system, an alignment system comprising at least three coils (or similar circuits) on a magnetically permeable substrate receives a positioning magnetic field including modulated information signals and processes the received signal to generate an output for determining the position of a positioning magnetic field source relative to the magnetic field sensor position. The alignment system may further comprise a similar structure that generates the positioning magnetic field that may include modulated information signals, based on input signals.

However, these systems which guide positioning and alignment to provide coupling between the wireless charging transmitter and receiver are all for cars. The battery and the charging type of cars are not applicable for electric wheelchairs based on at least the following reasons:

1. The high-power wireless charging or power supply applied on cars produces large radiation and transmission intensity, which seriously affect human health, especially for people with limited mobility who usually sit on the wheelchair during charging. In addition, the high-power wireless charging also brings environmental pollution, and it is difficult to meet international safety standards.

2. Using this type of guidance and alignment systems for wireless charging, it is necessary to align with the central points of the wireless charging transmitter and the receiver before charging and the error is usually within the millimeter range. This is obviously not an easy task for the people with limited mobility.

3. Not only requiring the center point alignment of the wireless charging transmitter and the receiver, but also maintaining an appropriate distance between the wireless charging transmitter and the receiver is also needed, otherwise the charging effect will be very much affected. Therefore, such systems further aggravate the inconvenience for the people with limited mobility.

### SUMMARY OF THE INVENTION

One object of the present invention is to provide an intelligent power wireless charging system which provides an easier and more convenient way of wireless charging for electric wheelchairs.

Another object of the present invention is to provide a robotic arm of the intelligent power wireless charging system for automatic wireless charging, which solves the trouble of manual charging.

A further object of the present invention is to provide a ranging sensor for guiding the electric wheelchair to the wireless charging robotic arm for wireless charging through indoor positioning technology, which solves the trouble of manual charging.

To achieve the objects, the present invention provides an intelligent power wireless charging system for electric wheelchairs, including: a wireless charging transmitter connected to power supply, the wireless charging transmitter has a transmitter host and a robotic arm with transmitter pad; a wireless charging receiver installed in the electric wheelchair; when the electric wheelchair is driven to the wireless charging transmitter within a certain area, the wireless charging transmitter host receives the signal from the wireless charging receiver of the electric wheelchair, a ranging sensor detects the position of the electric wheelchair, a laser sensor emits reference lines for guiding the electric wheelchair to be parked within the predefined charging position; after the electric wheelchair is parked within the charging position for a certain period of time, the robotic arm is activated and carried with the transmitter pad from the standby position to the predefined charging position; after the transmitter pad is paused at the charging position for a certain period of time, the ranging sensor is activated and detects the position of the electric wheelchair, and the robotic arm automatically finds the wireless charging receiver to charge through automatic tracking technology; when the charging is completed, the robotic arm automatically returns to the standby position.

In line with the current development of electric wheelchairs on the market, all functions and design purposes are to enable electric wheelchair users to enjoy a more convenient, environmental friendly and new safe lifestyle.

By simply installing the wireless charging receiver in the wheelchair and the wireless charging transmitter on the wall or a special bracket realize the communication between the electric wheelchair and the wireless charging transmitter, so that the wireless charging can be achieved.

By emitting reference lines on the ground from the laser sensor achieves guiding to guide the electric wheelchair to park easily within the predefined charging position.

By detecting the position of the electric wheelchair through the ranging sensor helps the robotic arm automatically find the wireless charging receiver to charge through automatic tracking, so that the wireless charging can be achieved more conveniently.

Adopting automatic tracking used by the robotic arm, the robotic arm carries the transmitter pad gradually close to the wireless charging receiver and finally aligns with the wireless charging receiver to achieve power charging. When the charging is complete, the robotic arm returns back to the standby position. In addition, the electric wheelchair can also be parked within a certain range in the charging position to make the multi-angle charging possible.

In summary, it is really convenient for people with limited mobility.

To better understand the nature and advantages of the present invention, reference should be made to the following description and the accompanying figures. It should be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a schematic view of electric wheelchair charging according to the present invention;

FIG. 2 is a schematic view of installing the receiver on the armrest of the electric wheel according to the present invention;

FIG. 3 is a schematic view of the height from the ground to the center point of the receiver according to the present invention;

FIG. 4 is a schematic view of the central point of the wireless charging transmitter should be of the same height as the central point of the wireless charging receiver according to the present invention;

FIG. 5 is a schematic view that the front pedal edge of the electric wheelchair near the laser line according to the present invention;

FIG. 6 is a schematic view of rotating the laser knob below the host to align with the laser crosshairs to the front pedal edge of the electric wheelchair according to the present invention;

FIG. 7 is a schematic view of the multi-angle charging according to the present invention;

FIG. 8 is a schematic view of the charging position according to the present invention;

FIG. 9 is a schematic view of the functional buttons according to the present invention;

FIG. 10 is a schematic view of the electric wheelchair travel range according to the present invention;

FIG. 11 is a robotic arm of the intelligent power wireless charging system for automatic wireless charging according to the present invention;

FIG. 12 is a ranging sensor of the intelligent power wireless charging system for automatic wireless charging according to the present invention;

FIG. 13 is one kind of ranging sensor of the intelligent power wireless charging system for automatic wireless charging according to the present invention;

FIG. 14 is another kind of ranging sensor of the intelligent power wireless charging system for automatic wireless charging according to the present invention;

FIG. 15 is another kind of ranging sensor of the intelligent power wireless charging system for automatic wireless charging according to the present invention;

FIG. 16 is another kind of ranging sensor of the intelligent power wireless charging system for automatic wireless charging according to the present invention;

FIG. 17 is another kind of ranging sensor of the intelligent power wireless charging system for automatic wireless charging according to the present invention;

FIG. 18 is another kind of ranging sensor of the intelligent power wireless charging system for automatic wireless charging according to the present invention;

FIG. 19 is another kind of ranging sensor of the intelligent power wireless charging system for automatic wireless charging according to the present invention;

FIG. 20 is another kind of ranging sensor of the intelligent power wireless charging system for automatic wireless charging according to the present invention;

FIG. 21 is another kind of ranging sensor of the intelligent power wireless charging system for automatic wireless charging according to the present invention;

FIG. 22 is another kind of ranging sensor of the intelligent power wireless charging system for automatic wireless charging according to the present invention;

FIG. 23 is another kind of ranging sensor of the intelligent power wireless charging system for automatic wireless charging according to the present invention;

FIG. 24 is another kind of ranging sensor of the intelligent power wireless charging system for automatic wireless charging according to the present invention.

### DETAILED DESCRIPTION OF THE INVENTION

The present invention would be further described herein with reference to the accompanying drawings and embodiments of the present invention. While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It is to be understood that such terms as “left,” “right,” “top,” “bottom,” “front,” “rear,” “side,” “height,” “length,” “width,” “upper,” “lower,” “interior,” “exterior,” “inner,” “outer” and the like may be used herein. They merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

The present invention provides an intelligent power wireless charging system for electric wheelchairs, including: a wireless charging transmitter connected to power supply, the wireless charging transmitter has a transmitter host and a robotic arm with transmitter pad; a wireless charging receiver installed in the electric wheelchair; when the electric wheelchair is driven to the wireless charging transmitter within a certain area, the wireless charging transmitter host receives the signal from the wireless charging receiver of the electric wheelchair, a ranging sensor of the wireless charging transmitter detects the position of the electric wheelchair, a laser sensor of the wireless charging transmitter emits reference lines for guiding the electric wheelchair to be parked within the predefined charging position; after the electric wheelchair is parked within the charging position for a certain period of time, the robotic arm is activated and carries the transmitter pad from the standby position to the predefined charging position; after the transmitter pad is paused at the charging position for a certain period of time, the ranging sensor is activated and detects the position of the electric wheelchair, and the robotic arm automatically finds the wireless charging receiver to charge through automatic tracking technology; when the charging is completed, the robotic arm automatically returns to the standby position.

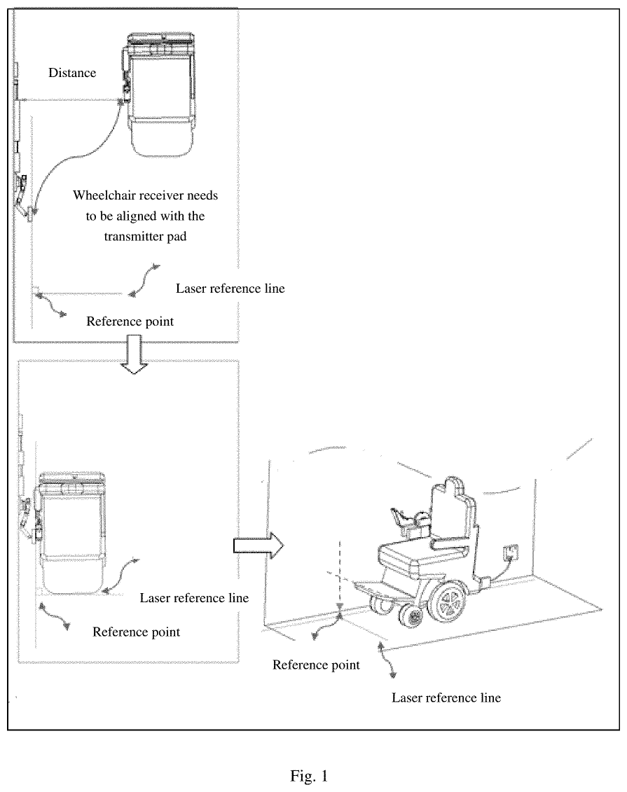

FIG. 1 is a schematic view of electric wheelchair wireless charging according to the present invention. With respect to the intelligent power charging system for electric wheelchairs, the wireless charging transmitter should be connected to the AC power to make this system work. When the wheelchair user drives the electric wheelchair to the wireless charging transmitter within a certain area (for example 1 meter), it needs to meet the following three conditions to perform charging:

1. The wireless charging transmitter receives the signal (for example Bluetooth communication signal) from the wireless charging receiver installed in the electric wheelchair;

2. The electric wheelchair is parked at the predefined charging position; and

3. The electric wheelchair is parked for a certain period of time (for example more than 5 seconds).

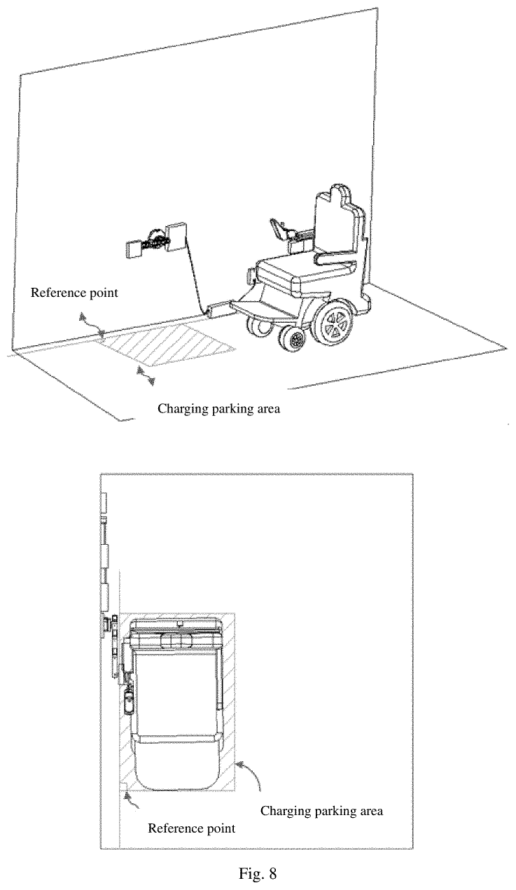

Specifically, the wireless charging transmitter receives the Bluetooth communication signal from the wireless charging receiver, the ranging sensor of the wireless charging transmitter emits laser rays to the wireless charging receiver and receives the reflected back laser rays from the wireless charging receiver. The time differences of the back and forth laser rays are used to calculate the distance between the wireless charging transmitter of the electric wheelchair and wireless charging receiver. When the wireless charging transmitter confirms the electric wheelchair is moved in the charging position, the laser sensor installed at the bottom of the wireless charging transmitter emits laser lines and draws laser crosshair on the ground. The laser crosshair is referenced charging position for the electric wheelchair (as shown in FIG. 8). The electric wheelchair user needs to drive the electric wheelchair into the laser crosshair area, waiting for the wireless charging transmitter to further confirm the position of the electric wheelchair (the electric wheelchair). The electric wheelchair does better by not moving after pausing at the charging position and needs to be parked at the charging position for a certain period of time (for example more than 5 seconds).

After the wireless charging transmitter confirms that the above-mentioned three conditions, the robotic arm is activated and carried with the transmitter pad from the standby position to the predefined charging position.

After the transmitter pad pauses a certain period of time (for example 2 seconds) at the charging position, the ranging sensor is activated and emits laser rays to the electric wheelchair. The laser rays are reflected back from the wireless charging receiver of the electric wheelchair. The ranging sensor calculates the distance and angle between the transmitting and receiving ends of wireless charging receiver and the wireless charging transmitter. These laser data for analysis are converted into pulse signals. After calculation, the stepping motors mounted on different joints of the robotic arm are driven respectively. These stepping motors are equivalent to the joints of humans, and the stepping motors drive the robotic arm to move toward the wireless charging receiver of the electric wheelchair, thereby driving the transmitter pad to align with the wireless charging receiver. During the movement of the robotic arm to the wireless charging receiver, the ranging sensor continuously transmits the laser rays and receives the reflected laser rays, and the analysis data are continuously converted into the pulse signals for driving the stepping motors until the transmitter pad aligns with the wireless charging receiver.

When the transmitter pad and the wireless charging receiver are in the correct positions, the wireless charging transmitter makes a “click” sound, the LED light on the wireless charging transmitter will be on light (for example red light) and flash at the same time to indicate the electric wheelchair in the charging state. During the charging process, the electric wheelchair user can leave the electric wheelchair. When the battery of the electric wheelchair is fully charged, the LED light will be on light (for example green light) and the robotic arm automatically returns to the standby position, and then the electric wheelchair user can drive the electric wheelchair away. However, if the electric wheelchair user needs to drive the electric wheelchair to leave during charging, the user needs to press the “stop charging” button set on the transmitter pad to let the robotic arm return to the standby position first and then drive the electric wheelchair away. When the electric wheelchair is out of the charging position, the LED light will be on light (for example blue light) to show the charging standby state.

In the embodiments of the present invention, the intelligent robotic arm carrying the transmitter pad can automatically search and move to the position of the wireless charging receiver. When the wireless charging transmitter pad and the wireless charging receiver are aligned, the wireless charging starts. The robotic arm automatically returns to the standby position after the charging is finished. During the movement of the robotic arm to the wireless charging receiver, the ranging sensor on the transmitter pad continuously transmits and receives the reflected signals, and the analysis data are continuously converted into pulse signals for driving the stepping motors until the transmitter pad moves to align with the wireless charging receiver to achieve the automatic tracking.

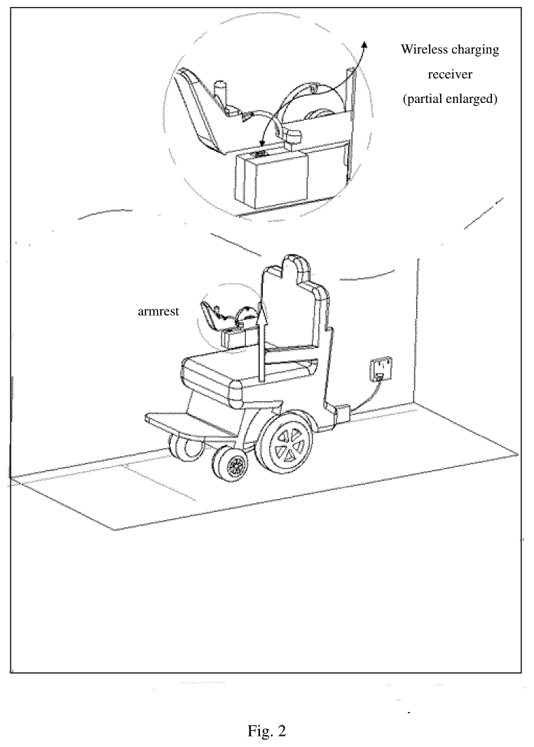

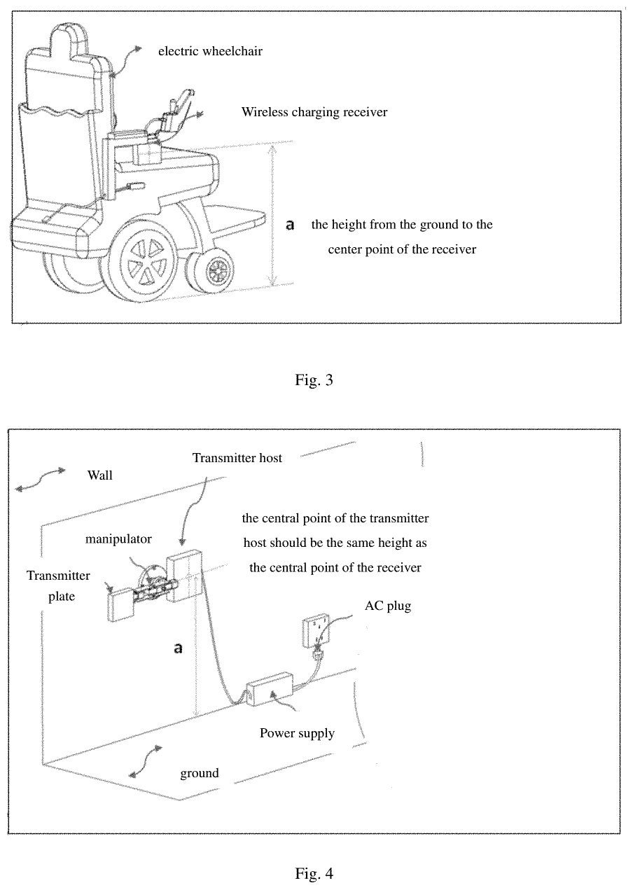

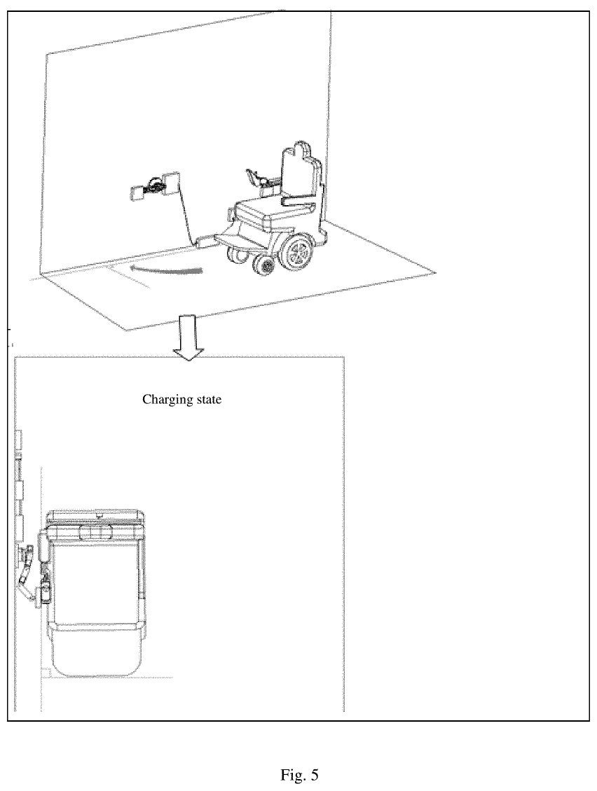

The wireless charging transmitter is mounted on the wall or on a special bracket. In the embodiments of the present invention, this is a one-time initial installation and does not require repeated installation. However, if the height of the seat changes, the initial charging seat height can be adjusted through starting another initial installation. First, the electric wheelchair user needs to adjust the wheelchair seat to the seat comfort height, which is the initial charging seat height during wireless charging. When this height is confirmed, the electric wheelchair seat height must be maintained every time for wireless charging. The same initial charging seat height must be kept, otherwise the robotic arm does not work properly. The wireless charging receiver is installed in the armrest (for example right armrest, referring to FIG. 2) of the electric wheelchair. The height of the wireless charging receiver to the ground is measured (referring to FIG. 3). The wireless charging transmitter is preferably placed in the right armrest. If the wireless charging transmitter is set in the left armrest, the extension line is usually added to insert the charging wire plug into the wire socket under the wireless charging transmitter. Using the height of the wireless charging receiver to the ground as reference, the height of the center point of the wireless charging transmitter should be the same as the height of the center point of the wireless charging receiver (referring to FIG. 4). The wireless charging transmitter connects to the AC power to make this system work. When pressing the initial installation button on wireless charging transmitter, the robotic arm extends to the initial installation position and second laser sensor on the wireless charging transmitter emits laser lines and draws laser crosshair on the ground.

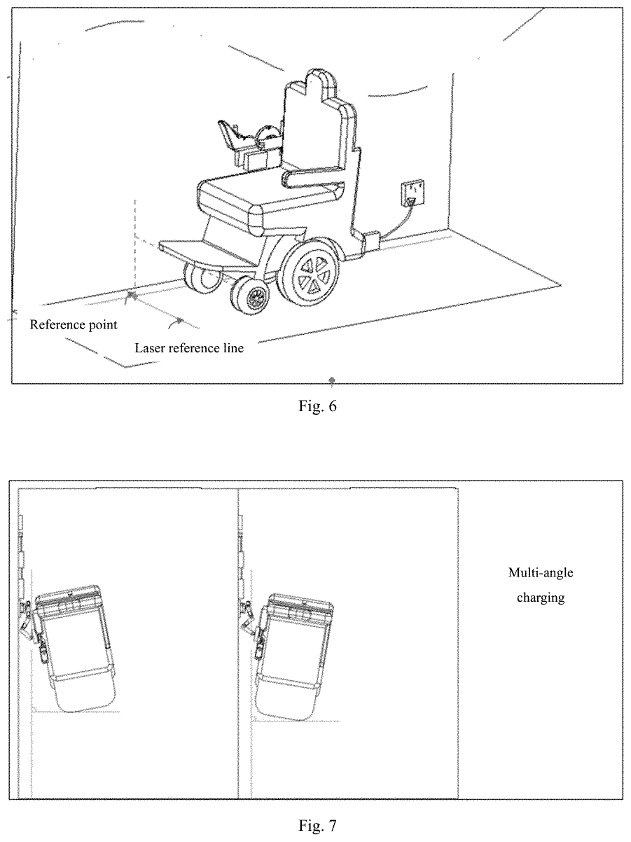

With respect to the wireless charging transmitter fixation program, the electric wheelchair is first moved close to the location where the wireless charging transmitter is installed, the position of the electric wheelchair is adjusted so that the center point of the wireless charging receiver is immersed in the center point of the circular projection plane of the transmitter pad of the robotic arm, the horizontal position of the robotic arm (for example by using the level gauge) is adjusted and fixed the wireless charging transmitter on the wall (referring to FIG. 5). The laser position adjustment knob on the wireless charging transmitter is rotated to align with the laser crosshair with the edge of the front footboard of the electric wheelchair. The laser crosshair drawn on the ground is the charge position for the electric wheelchair (referring to FIG. 6). By pressing the stop charging button on the transmitter pad, the robotic arm automatically returns to the standby position. The entire system is initially installed and ready for use.

In the embodiment of the present invention, there is a LED light on the wireless charging transmitter to display the charging status, wherein red light means in charging progress; blue light means standby state; green light means that the battery is fully charged. Of course, there are other colors that can correspond to different functions, and are not limited herein.

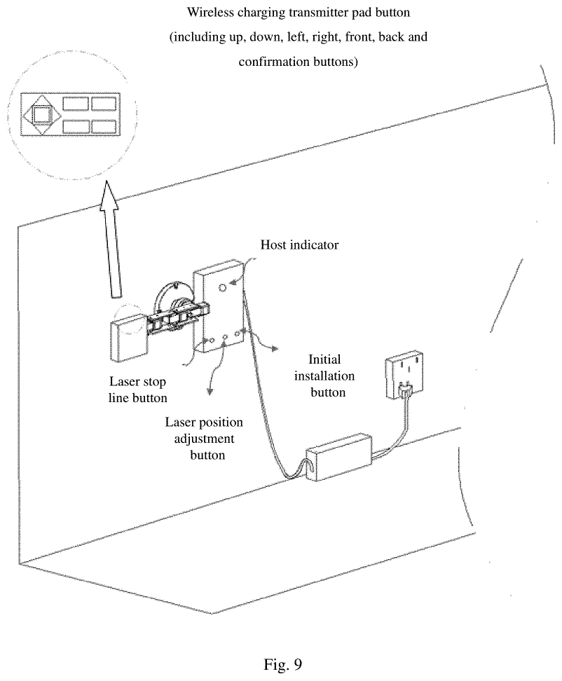

In the embodiment of the present invention, the transmitter pad is provided with a stop charging button, a manual charging button, and a set of buttons for robotic arm (referring to FIG. 9). When the stop charging button is pressed, the wireless charging process stops immediately and the robotic arm automatically returns to the standby position. When the manual charging button is pressed, the robotic arm automatically extends to the charging position and the electric wheelchair user needs to drive the electric wheelchair to the laser parking reference line. The electric wheelchair user also controls the set of buttons for robotic arm to manually drive the transmitter pad to move up, down, left, and right, forward and backward, until the circular-shaped collar on the transmitter pad aligns with the circular-shaped depression of the wireless charging receiver.

In the embodiment of the present invention, the wireless charging transmitter is provided with a laser stop line button, an initial installation button and a laser position adjustment knob. When the laser stop line button is pressed, the red laser parking reference lines are drawn on the ground. When the wireless charging transmitter is initially installed, the initial installation button is pressed to extend the robotic arm to the initial installation position, and the laser sensor simultaneously emits the laser crosshair. When the laser position adjustment knob is rotated, the laser crosshair can be adjusted during the initial installation process.

In the embodiment of the present invention, the wireless charging receiver is provided with a LED light, and its function is to display the battery state of the receiver. If the LED light is flashing, the electric wheelchair is in low battery status and should be charged. The LED light is flashed for a certain period of time (for example 10 minutes) as a reminder. This reminder stops after a certain period of time (for example 10 seconds of flashing every 10 minutes). The cycle is for about 24 hours. The electric wheelchair user should find transmitter to charge, otherwise the electric wheelchair will be out of power and the communication between the wireless charging receiver and the wireless charging transmitter will be interrupted, and the robotic arm automatic tracing charging function will not work when the communication is interrupted.

In practical applications, when the electric wheelchair is parked within the charging position, it will more or less tilt forward and backward or at an angle. The parking reference angle of the electric wheelchair can fall within the parking line range to achieve the multi-angle charging, for example the parking deviation angle cannot be less than +/−20 degrees. If the electric wheelchair parking status meets the above requirements, the robotic arm automatically finds the center point of the wireless charging receiver through automatic tracking technology. If the charging position exceeds the charging position, the wireless charging transmitter continuously emits a warning sound or signal since the robotic arm cannot work normally. If the electric wheelchair is parked too close to the wireless charging transmitter, the robotic arm may bump with the electric wheelchair during automatic tracking. The robotic arm automatically returns to the charging position and it needs to operate charging in artificial wireless charging mode. When the robotic arm moves, if there is an obstacle, the robotic arm will pause the movement and continue to move when the obstacle is far away.

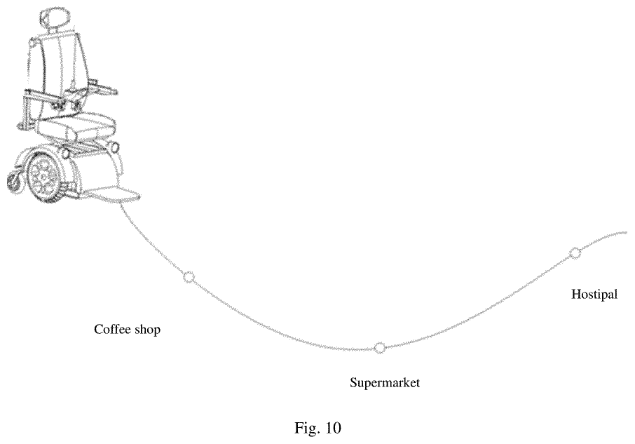

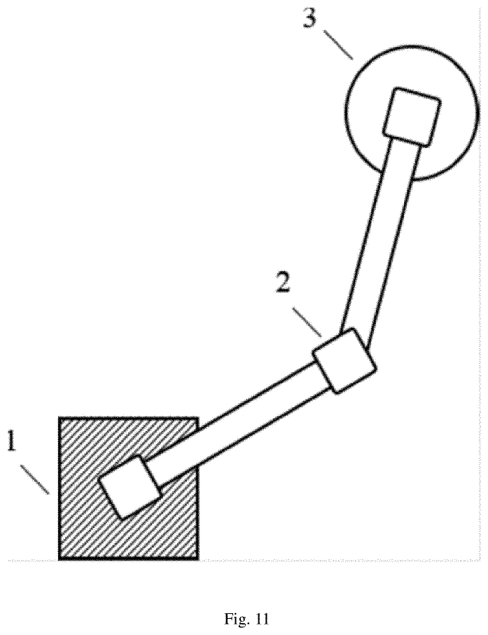

The electric wheelchair battery has limited energy and its cruising range is about 20 kilometers. Because of the need for round-trip, the electric wheelchair user can only move within the radius of 10 kilometers, thus limiting the range of activities of the electric wheelchair user. If the system is installed in various public places, such as libraries, cafes, supermarkets, community clubs, hospitals, etc., the electric wheelchair user can recharge while moving, and the range of activities will be much wider. At present, the system also can be added to the smartphone APP operating system to achieve charging charges. APP map on the smartphone is used to view the distribution of nearby charging points and its route, etc., so as to make the wheelchair user as ordinary as possible and can free to move around (referring to FIG. 10).

Referring to FIG. 11, the present invention also provides a robotic arm for automatic wireless charging, which solves the trouble of manual charging. The robotic arm is one part of the wireless charge transmitter and includes a base 1, a mechanical arm 2 and a wireless charging device 3, wherein the mechanical arm 2 is installed on the base 1, and the front-end mechanical arm is connected with wireless charging device 3 to charge the electric wheelchair in wireless way.

In one embodiment, the mechanical arm is a hydraulic mechanical arm. The method for wireless charging of the hydraulic driven mechanical arm includes: the hydraulic mechanical arm is installed on the base, the front of mechanical arm is connected with wireless charging device, which can charge the electric wheelchair wirelessly.

In one embodiment, the mechanical arm is a pneumatic mechanical arm. The method for wireless charging of pneumatic mechanical arm includes: the pneumatic mechanical arm is installed on the base, the front of mechanical arm is connected with wireless charging device, which can charge the electric wheelchair wirelessly.

In one embodiment, the mechanical arm is an electromagnetically driven mechanical arm. The method for wireless charging of electromagnetically drive mechanical arm includes: the mechanical arm with electromagnetic motor is installed on the base, the electromagnetic motor driving the mechanical arm to move, the front of mechanical arm is connected with wireless charging device, which can charge the electric wheelchair wirelessly.

In one embodiment, the mechanical arm is a piezoelectrically driven mechanical arm. The method for wireless charging of piezoelectrically driven mechanical arm includes: the mechanical arm with piezoelectric motor is installed on the base, the piezoelectric motor can drive the mechanical arm to move, the front of mechanical arm connected with wireless charging device, which can charge the electric wheelchair wirelessly.

In one embodiment, the mechanical arm is a shape memory material driven mechanical arm. The method for wireless charging of the shape memory material driven mechanical arm includes: the shape memory materials is installed on the base, the deformation of the shape memory materials by temperature changes so as to drive the mechanical arm, the front end mechanical arm is installed with wireless charging device, which can charge the electric wheelchair wirelessly.

In one embodiment, the mechanical arm is a tractor driven mechanical arm. The method for wireless charging of tractor driven mechanical arm includes: the tractor driven mechanical arm is installed on the base, through the force make the mechanical arm to produce movement, the front of mechanical arm is connected with wireless charging device, which can charge the electric wheelchair wirelessly.

In one embodiment, the mechanical arm is an electroactive polymer driven mechanical arm. The method for wireless charging of electroactive polymer driven mechanical arm includes: the electroactive polymer driven mechanical arm is installed on the base, the electroactive polymer can change form after electricity to drive the mechanical arm to move, the front of mechanical arm is connected with wireless charging device, which can charge the electric wheelchair wirelessly.

In one embodiment, the mechanical arm is an electrically driven mechanical arm. The method for wireless charging of electrically driven mechanical arm includes: the electrically mechanical arm with motor is installed on the base, the motor can drive the mechanical arm to move, the front of mechanical arm is connected with wireless charging device, which can charge the electric wheelchair wirelessly.

In one embodiment, the mechanical arm is a mechanically driven mechanical arm. The method for wireless charging of mechanically driven mechanical arm includes: the mechanical arm is installed on the base, the mechanical arm is equipped with gears and driven by mechanical transmission of gears, the front of mechanical arm is connected with wireless charging device, which can charge the electric wheelchair wirelessly.

The mechanical arms described in the above embodiments are only of functional descriptions, in other forms to achieve the same function of the mechanical structure are protected within this patent scope.

The present invention also provides a ranging sensor for guiding the electric wheelchair to the wireless charging robotic arm for wireless charging. The ranging sensor includes a first sensor placed in a predefined location, a second sensor equipped on the electric wheelchair. In another embodiment, the ranging sensor includes a first sensor equipped on the electric wheelchair, and a wireless sensor equipped on the wireless charging device.

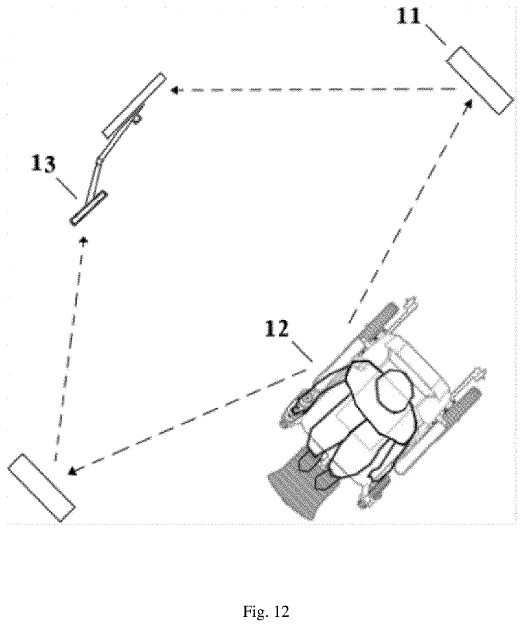

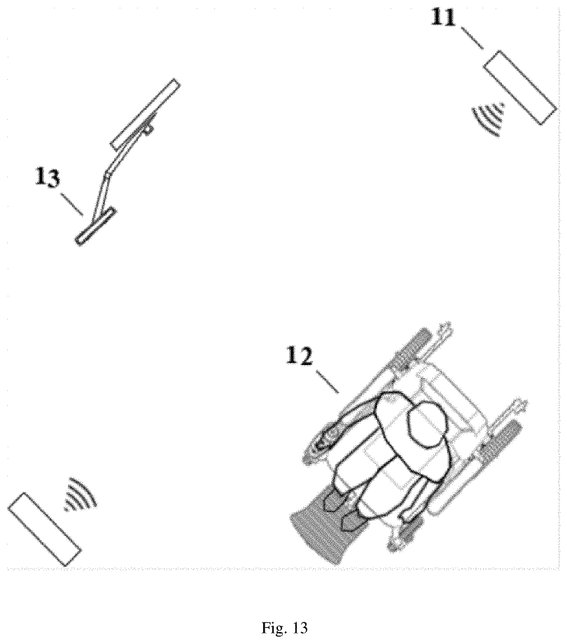

In one embodiment, referring to FIG. 12, the ranging sensor is ultrasonic sensor. In the embodiment of the present invention, the ultrasonic sensor calculates the distance between the wireless charging receiver of the electric wheelchair and the ranging sensor according to the principle of Distance=Ray speed×time. The method for wireless charging of electric wheelchair by locating through the ultrasonic sensor includes: the ultrasonic sensor 11 is placed in a predefined location; the electric wheelchair is equipped with ultrasonic transmitter 12 which transmits the ultrasonic signal to the ultrasonic sensor 11, so that the ultrasonic sensor 11 can calculate the distance according to the time difference between the echo and the transmitted wave to determine the location of the electric wheelchair and then calculate positioning coordinates of the electric wheelchair; the ultrasonic sensor 11 sends the positioning coordinates of the electric wheelchair to the wireless charging device 13; when the electric wheelchair travels to the effective charging range from the wireless charging device 13, the wireless charging device 13 can automatically charge the electric wheelchair.

In one embodiment, referring to FIG. 12, the ranging sensor is an infrared sensor. The method for wireless charging of electric wheelchair by locating through the infrared sensor includes: the infrared sensor 11 is placed in a predefined location; the electric wheelchair is equipped with infrared electronic tag 12 which transmits the infrared signal to the infrared sensor 11, so that the infrared sensor 11 can determine the positioning coordinates of the electric wheelchair; the infrared sensor 11 sends the positioning coordinates of the electric wheelchair to the wireless charging device 13; when the electric wheelchair travels to the effective charging range from the wireless charging device 13, the wireless charging device 13 can automatically charge the electric wheelchair.

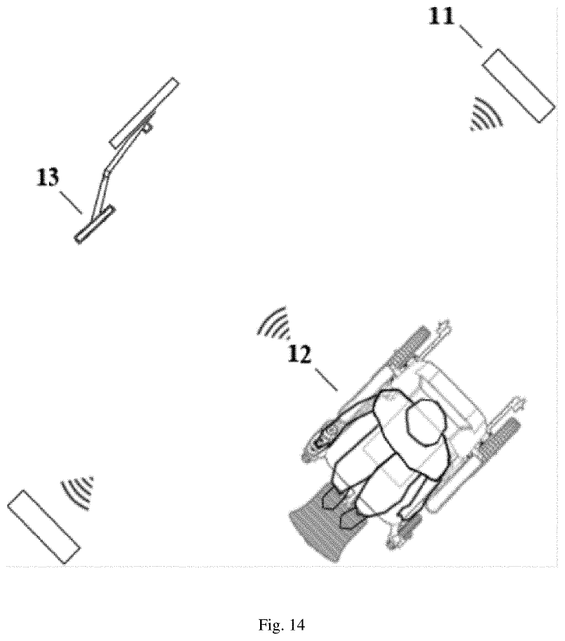

In one embodiment, referring to FIG. 13, the ranging sensor is a wireless sensor adopting ultra-wideband (UWB) positioning technology. The method for wireless charging of electric wheelchair by locating through the wireless sensor includes: the wireless sensor 11 is placed in a predefined location; the electric wheelchair is equipped with a positioning device 12, the wireless sensor 11 can obtain the positioning coordinates of electric wheelchair through the positioning device 12 and then sends the positioning coordinates of the electric wheelchair to the wireless charging device 13; when the electric wheelchair travels to the effective charging range from the wireless charging device, the wireless charging device 13 can automatically charge the electric wheelchair.

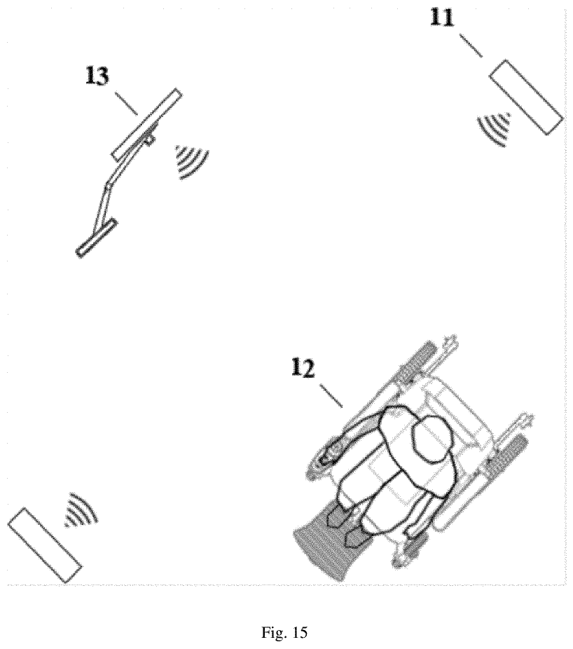

In one embodiment, referring to FIG. 14, the ranging sensor is a reader adopting RFID positioning technology. The method for wireless charging of electric wheelchair by locating through the reader includes: the reader 11 is placed in a predefined location; the electric wheelchair is equipped with RFID tags 12, the reader 11 can obtain the positioning coordinates of electric wheelchair through the RFID tags 12 and then sends the positioning coordinates of the electric wheelchair to the wireless charging device 13; when the electric wheelchair travels to the effective charging range from the wireless charging device, the wireless charging device 13 can automatically charge the electric wheelchair.

In one embodiment, referring to FIG. 15, the ranging sensor is a bluetooth beacon base station. The method for wireless charging of electric wheelchair by locating through the bluetooth beacon base station includes: the bluetooth beacon base station 11 is placed in a predefined location; the electric wheelchair is equipped with bluetooth positioning device 12, the wireless charging device 13 is equipped with beacon equipment which continuously broadcasts signals and data packets to the surroundings; when the electric wheelchair enters beacon equipment signal coverage, coordinate information can be obtained by bluetooth positioning device 12; when the electric wheelchair travels to the effective charging range from the wireless charging device, the wireless charging device 13 can automatically charge the electric wheelchair.

In one embodiment, referring to FIG. 15, the ranging sensor is a bluetooth gateway. The method for wireless charging of electric wheelchair by locating through the bluetooth gateway includes: the bluetooth gateway 11 is placed in a predefined location; the electric wheelchair is equipped with bluetooth positioning device 12, the wireless charging device 13 is equipped with beacon equipment which continuously broadcasts signals and data packets to the surroundings; when the electric wheelchair enters beacon equipment signal coverage, coordinate information can be obtained by bluetooth positioning device; when the electric wheelchair travels to the effective charging range from the wireless charging device, the wireless charging device can automatically charge the electric wheelchair.

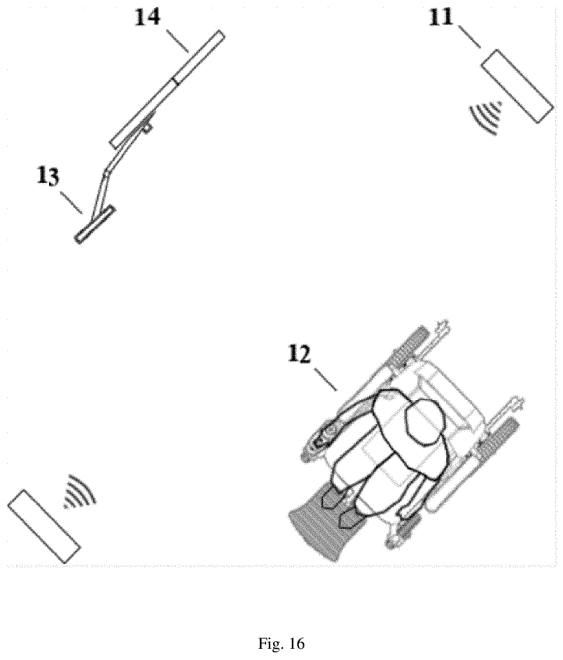

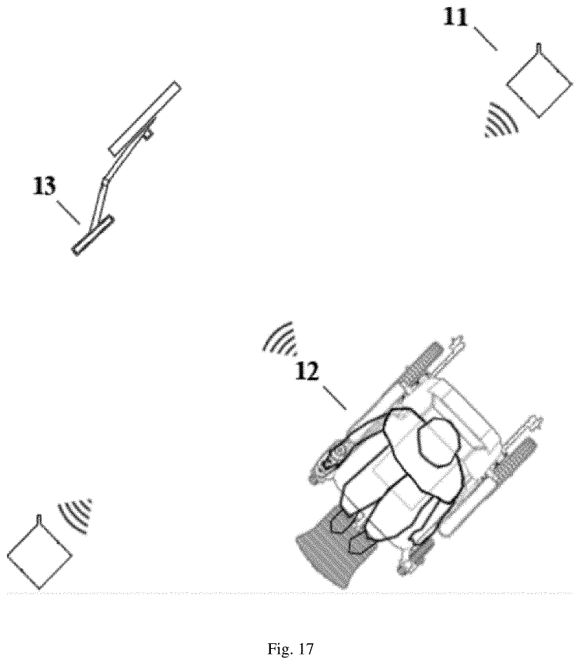

In one embodiment, referring to FIG. 16, the ranging sensor is a WIFI location hotspot. The method for wireless charging of electric wheelchair by locating through the WIFI location hotspot includes: the WIFI location hotspot 11 is placed in a predefined location; the electric wheelchair is equipped with WIFI communication hotspot 12, the wireless charging device 13 is equipped with beacon equipment which continuously broadcasts signals and data packets to the surroundings; when the electric wheelchair enters beacon equipment signal coverage, coordinate information can be obtained by bluetooth positioning device; when the electric wheelchair travels to the effective charging range from the wireless charging device, the wireless charging device can automatically charge the electric wheelchair.

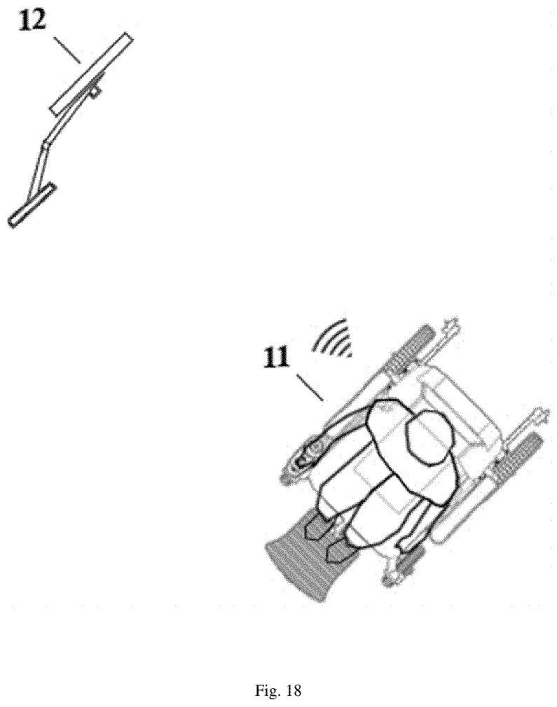

In one embodiment, referring to FIG. 17, the ranging sensor is a ZigBee network system. The method for wireless charging of electric wheelchair through ZigBee positioning technology includes: ZigBee coordinator, ZigBee router and ZigBee terminal are placed in predefined locations to form the ZigBee network 11; the electric wheelchair is equipped with monitoring device 12, so that the ZigBee network can calculate the electric wheelchair positioning coordinates and then sends the positioning coordinates of the electric wheelchair to the wireless charging device 13; when the electric wheelchair travels to the effective charging range from the wireless charging device, the wireless charging device 13 can automatically charge the electric wheelchair.

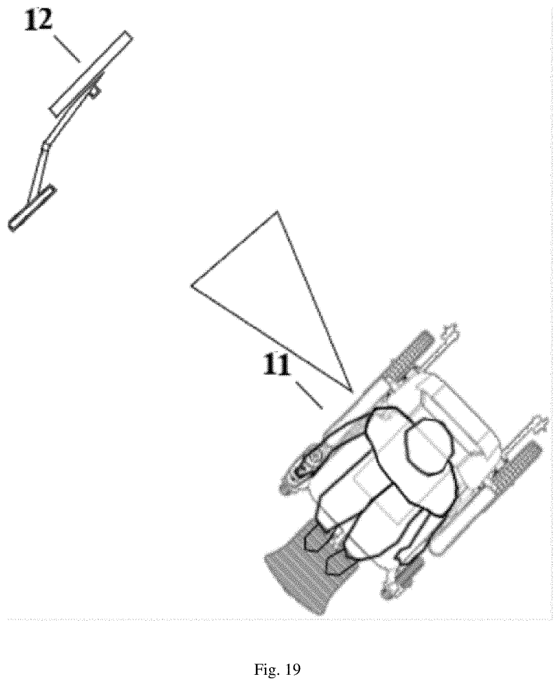

In one embodiment, referring to FIG. 18, the ranging sensor is navigation device, the navigation device includes gyroscope device and wireless sensor. The method for wireless charging of electric wheelchair through inertial navigation positioning technology includes: the electric wheelchair is equipped with the navigation device 11, the position coordinates of the electric wheelchair are obtained by the algorithm, and the position coordinates are transmitted to the wireless charging device 12, and the position coordinate can be corrected by auxiliary technologies and algorithms; when the electric wheelchair travels to the effective charging range from the wireless charging device, the wireless charging device 12 can automatically charge the electric wheelchair.

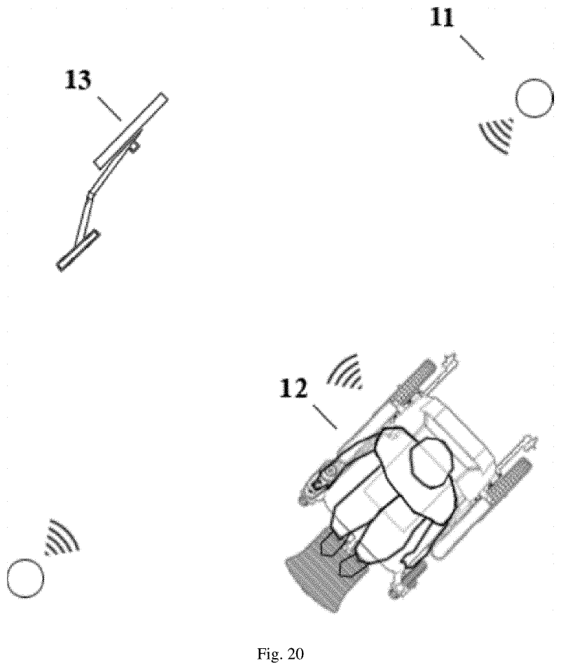

In one embodiment, referring to FIG. 19, the ranging sensor is camera system, the camera system includes camera and wireless sensor. The method for wireless charging of electric wheelchair through simultaneous localization and mapping (SLAM) technology includes: the electric wheelchair is equipped with the camera system 11; after the camera takes photos, the photos are sent to the data processor on the wireless charger through the wireless sensor for image matching processing, and the corresponding coordinates are sent to the wireless sensor on the electric wheelchair; when the electric wheelchair travels to the effective charging range from the wireless charging device, the wireless charging device 12 can automatically charge the electric wheelchair.

In one embodiment, referring to FIG. 20, the ranging sensor is pseudolite antenna adopting pseudo-satellite positioning technology. The method for wireless charging of electric wheelchair through pseudo-satellite positioning technology includes: the light source 11 is placed in a predefined location; the electric wheelchair is equipped with LIFI reader and transmitter 12; the LIFI reader obtains the special signal of the light source 11 placed in different positions, calculates the positioning coordinates, and transmits the coordinate coordinates to the wireless sensor on the wireless charging device 13 through the LIFI transmitter; when the electric wheelchair travels to the effective charging range from the wireless charging device, the wireless charging device 13 can automatically charge the electric wheelchair.

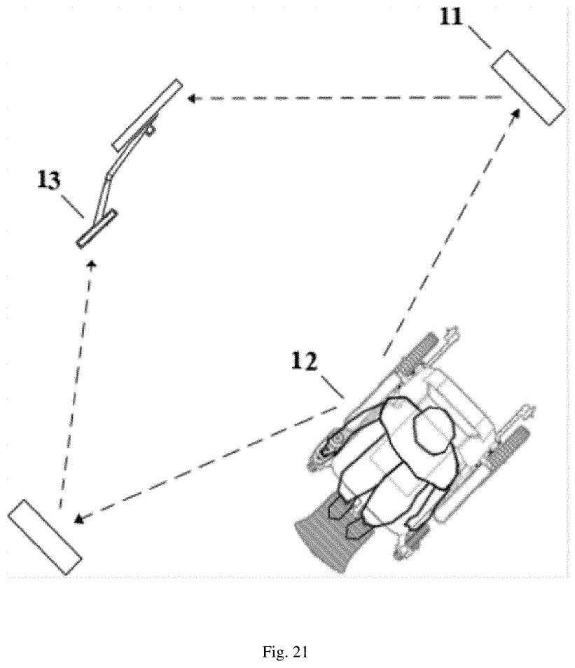

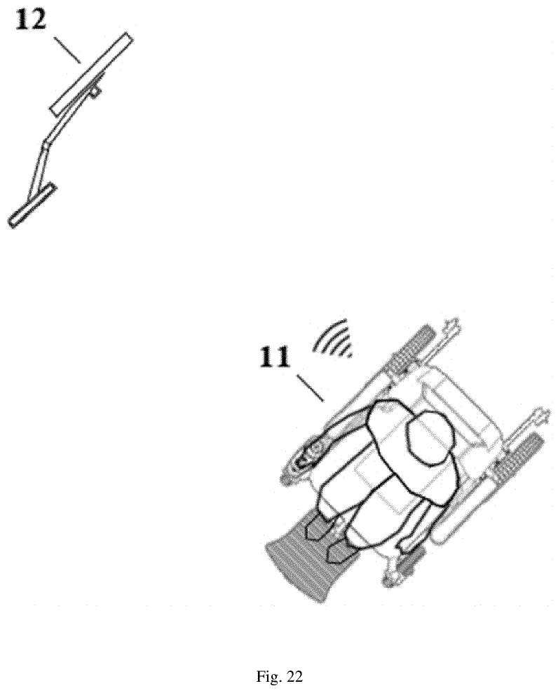

In one embodiment, referring to FIG. 21, the ranging sensor is pseudolite antenna adopting pseudolite positioning technology. The method for wireless charging of electric wheelchair through pseudolite positioning technology includes: the pseudolite antenna 11 is placed in a predefined location; the electric wheelchair is equipped with LIFI satellite receiver 12 and wireless sensor; the satellite and pseudolite antenna 11 send positioning coordinates to the satellite receiver 12 on the electric wheelchair in real time, and transmit satellite receiver 12 to the wireless sensor on the wireless charger 13 through the wireless sensor on the electric wheelchair; when the electric wheelchair travels to the effective charging range from the wireless charging device, the wireless charging device 13 can automatically charge the electric wheelchair.

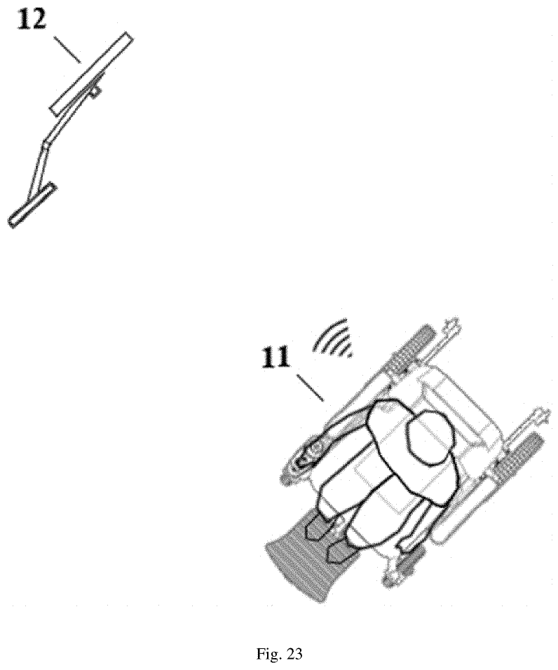

In one embodiment, referring to FIG. 22, the ranging sensor is magnetic sensor. The method for wireless charging of electric wheelchair through geomagnetic positioning technology includes: the electric wheelchair is equipped with the magnetic sensor 11; the natural magnetic field in the induction space is used to obtain the positioning coordinates of the electric wheelchair, and the positioning coordinates are transmitted to the wireless sensor on the wireless charging device 12; when the electric wheelchair travels to the effective charging range from the wireless charging device, the wireless charging device 12 can automatically charge the electric wheelchair.

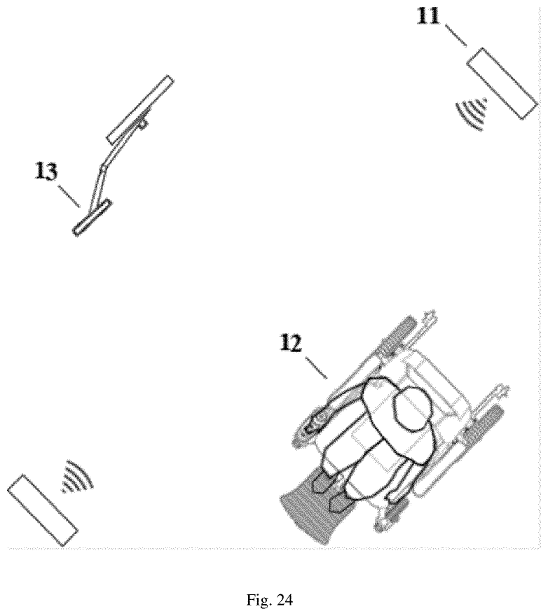

In one embodiment, referring to FIG. 23, the ranging sensor is telephone receiver and transmitter. The method for wireless charging of electric wheelchair through telephone signal network positioning technology includes: the electric wheelchair is equipped with the telephone receiver and transmitter 11; the positioning coordinates are obtained by receiving the telephone signal, and the positioning coordinates are transmitted to the wireless sensor on the wireless charging device 12 through the telephone signal network positioning technology; when the electric wheelchair travels to the effective charging range from the wireless charging device, the wireless charging device 12 can automatically charge the electric wheelchair.

In one embodiment, referring to FIG. 24, the ranging sensor is wireless sensor in space. The method for wireless charging of electric wheelchair through position fingerprint positioning technology includes: the wireless sensor in space 11 is placed in a predefined location; the electric wheelchair is equipped with wireless sensor 12; when the electric wheelchair travels to a place in the space, the wireless sensor in space 11 reads the signal from the wireless sensor 12 on the electric wheelchair, obtains the fingerprint signal in the database, and calculates the positioning coordinates of the electric wheelchair by comparison and algorithm; when the electric wheelchair travels to the effective charging range from the wireless charging device, the wireless charging device 13 can automatically charge the electric wheelchair.

In one embodiment, still referring to FIG. 24, the ranging sensor is wireless sensor in space. The method for wireless charging of electric wheelchair through local model positioning technology includes: the wireless sensor in space 11 is placed in a predefined location; the electric wheelchair is equipped with wireless sensor 12; when the electric wheelchair travels to a place in the space, by reading the spatial grid record model in the database and identifying the grid model, the position coordinates of the electric wheelchair are obtained by the local model positioning algorithm; when the electric wheelchair travels to the effective charging range from the wireless charging device, the wireless charging device 13 can automatically charge the electric wheelchair.

In one embodiment, still referring to FIG. 24, the ranging sensor is wireless sensor in space. The method for wireless charging of electric wheelchair through regression positioning technology includes: the wireless sensor in space 11 is placed in a predefined location; the electric wheelchair is equipped with wireless sensor 12; when the electric wheelchair travels to a place in the space, by reading the spatial grid record model in the database and identifying the grid model, the position coordinates of the electric wheelchair are obtained by the regression positioning algorithm; when the electric wheelchair travels to the effective charging range from the wireless charging device, the wireless charging device 13 can automatically charge the electric wheelchair.

In one embodiment, still referring to FIG. 24, the ranging sensor is spatial LPWAN wireless sensor. The method for wireless charging of electric wheelchair through LPWAN positioning technology includes: the spatial LPWAN wireless sensor 11 is placed in a predefined location; the electric wheelchair is equipped with wireless sensor 12; the LPWAN wireless sensor 11 senses and obtains position coordinates of electric wheelchair by algorithm, and transmits coordinates to wireless charging device 13; when the electric wheelchair travels to the effective charging range from the wireless charging device, the wireless charging device 13 can automatically charge the electric wheelchair.

The ranging sensor described in the above embodiments is only a functional description, in other forms to achieve the same function of the mechanical structure are protected within this patent scope.

It is to be understood that the embodiment of the present invention which has been described is merely illustrative of one application of the principles of the invention. Numerous modifications may be made to the specific structures and functions used in that embodiment without departing from the true spirit and scope of the invention.

What is claimed is:

1. An intelligent power wireless charging system for electric wheelchairs, comprises:
a wireless charging transmitter connected to a power supply, the wireless charging transmitter has a transmitter host and a robotic arm with transmitter pad;
a wireless charging receiver installed in the electric wheelchair;
when the electric wheelchair is driven to the wireless charging transmitter within a certain area, the wireless charging transmitter host receives the signal from the wireless charging receiver of the electric wheelchair, a ranging sensor detects the position of the electric wheelchair, a laser sensor emits reference lines for guiding the electric wheelchair to be parked within the predefined charging position;
after the electric wheelchair is parked within the charging position for a certain period of time, the robotic arm is activated and carries the transmitter pad from the standby position to the predefined charging position;
after the transmitter pad stays at the charging position for a certain period of time, the ranging sensor is activated and detects the position of the electric wheelchair, and the robotic arm automatically find the wireless charging receiver to charge through automatic tracking technology;
when the charging is completed, the robotic arm automatically returns to the standby position.

2. The intelligent power wireless charging system for electric wheelchairs of claim 1, wherein the wireless charging transmitter receives the Bluetooth communication signal from the wireless charging receiver, the ranging sensor emits laser rays, and the laser rays are reflected back to the ranging sensor from the wireless charging receiver, the time difference between the transmitting and receiving signals is to real calculate the distance and angle between the wireless charging transmitter and the wireless charging receiver.

3. The intelligent power wireless charging system for electric wheelchairs of claim 1, wherein the robotic arm with the transmitter pad automatically find the wireless charging receiver;
during the movement of the transmitter pad of the robotic arm to the wireless charging receiver, the ranging sensor continuously transmits the signals to the wireless charging receiver and receives the reflected signals from the wireless charging receiver, and the signals are continuously converted into pulse signals for driving the stepping motors to move the transmitter pad of the robotic arm automatically until the transmitter pad of the robotic arm aligns with the wireless charging receiver.

4. The intelligent power wireless charging system for electric wheelchairs of claim 1, wherein the wireless charging transmitter is mounted on the wall or on the special bracket on the wall; the wheelchair seat of the electric wheelchair is adjusted to the height as the initial charging seat height during wireless charging, the wireless charging receiver is installed in the armrest of the electric wheelchair; measuring the height of the wireless charging receiver to the ground and using the height of the wireless charging receiver to the ground as reference, the height of the center point of the wireless charging transmitter should be the same as the height of the center point of the wireless charging receiver.

5. The intelligent power wireless charging system for electric wheelchairs of claim 1, wherein the wireless charging transmitter has a LED light to display the charging status, wherein the LED light in the first color indicates in charging progress, the LED light in the second color represents standby state, and the LED light in the third color indicates that the battery of the electric wheelchair is fully charged.

6. The intelligent power wireless charging system for electric wheelchairs of claim 1, wherein the transmitter pad comprises a stop charging button, a manual charging button, and a set of buttons for robotic arm;
when the stop charging button is pressed, the wireless charging process is stopped and the robotic arm automatically returns to the standby position;
when the manual charging button is pressed, the robotic arm automatically extends to the charging position, the electric wheelchair user drives the electric wheelchair according to the laser parking reference lines, and controls the set of buttons for robotic arm to manually drive the transmitter pad to move until the transmitter pad aligns with the wireless charging receiver.

7. The intelligent power wireless charging system for electric wheelchairs of claim 1, wherein the wireless charging transmitter comprises a laser stop line button, an initial installation button and a laser position adjustment knob;
when the laser stop line button is pressed, the laser parking reference lines are drawn on the ground;
when initially installing the wireless charging transmitter, the initial installation button is pressed to extend the robotic arm to the initial installation position, and the laser sensor simultaneously emits the parking reference lines;
when the laser position adjustment knob is rotated, the laser parking reference lines can be adjusted during the initial installation process.

8. The intelligent power wireless charging system for electric wheelchairs of claim 1, wherein the wireless charging receiver comprise a LED light to display the battery state of the receiver; if the LED light is flashing, the electric wheelchair is in low battery status.

9. The intelligent power wireless charging system for electric wheelchairs of claim 1, wherein the electric wheelchair is parked at the charging position, the parking reference angle of the electric wheelchair falls within a certain range to achieve the multi-angle charging.

10. The intelligent power wireless charging system for electric wheelchairs of claim 9, wherein if the electric wheelchair needs to be moved during charging, the stop charging button on the transmitter pad is pressed firstly to let the robotic arm return to the standby position.

11. The intelligent power wireless charging system for electric wheelchairs of claim 1, wherein the robotic arm includes a base, a mechanical arm and a wireless charging device, wherein the mechanical arm is installed on the base, and the front-end mechanical arm is connected with wireless charging device to charge the electric wheelchair in wireless way.

12. The intelligent power wireless charging system for electric wheelchairs of claim 11, wherein the mechanical arm is one of the following: hydraulic mechanical arm, pneumatic mechanical arm, electromagnetically drive mechanical arm, electrostatically actuated mechanical arm, piezoelectric actuated mechanical arm, shape memory material driven mechanical arm, tractor-driven mechanical arm, electroactive polymer driven mechanical arm, electrically driven mechanical arm, and mechanically driven mechanical arm.

13. A ranging sensor for guiding the electric wheelchair to the wireless charging robotic arm for wireless charging, comprises: a first sensor placed in a predefined location, a second sensor equipped on the electric wheelchair, and a wireless charging device; wherein the first sensor obtained the positioning coordinates of the electric wheelchair through the communication between the first sensor and the second sensor and sends the positioning coordinates of the electric wheelchair to the wireless charging device; when the electric wheelchair travels to the effective charging range from the wireless charging device, the wireless charging device automatically charges the electric wheelchair.

14. The ranging sensor of claim 12, wherein the first sensor and the second sensor are as follows:
the first sensor is ultrasonic sensor and the second sensor is ultrasonic transmitter adopting ultrasonic positioning technology; or
the first sensor is infrared sensor and the second sensor is infrared electronic tag adopting infrared positioning technology; or
the first sensor is wireless sensor and the second sensor is wireless sensor adopting UWB positioning technology; or
the first sensor is reader and the second sensor is RFID tags adopting RFID positioning technology; or
the first sensor is bluetooth beacon base station and the second sensor is bluetooth positioning device adopting bluetooth beacon positioning technology; or
the first sensor is bluetooth gateway and the second sensor is bluetooth positioning device adopting bluetooth gateway positioning technology; or
the first sensor is WIFI location hotspot and the second sensor is WIFI communication hotspot adopting WIFI positioning technology; or
the first sensor is ZigBee network system and the second sensor is monitoring device adopting ZigBee positioning technology, wherein the ZigBee network system includes ZigBee coordinator, ZigBee router and ZigBee terminal; or
the first sensor is pseudolite antenna and the second sensor is LIFI satellite receiver adopting pseudolite positioning technology; or
the first sensor is wireless sensor in space and the second sensor is wireless sensor adopting pseudo-satellite positioning technology; or
the first sensor is wireless sensor in space and the second sensor is wireless sensor adopting position fingerprint positioning technology; or
the first sensor is wireless sensor in space and the second sensor is wireless sensor adopting local model positioning technology; or
the first sensor is wireless sensor in space and the second sensor is wireless sensor adopting regression positioning technology; or
the first sensor is wireless sensor in space and the second sensor is wireless sensor adopting LPWAN positioning technology.

15. A ranging sensor for guiding the electric wheelchair to the wireless charging robotic arm for wireless charging, comprises: a first sensor equipped on the electric wheelchair, and a wireless charging device with wireless sensor; wherein the first sensor obtains the position coordinates of the electric wheelchair and sends the positioning coordinates of the electric wheelchair to the wireless charging device; when the electric wheelchair travels to the effective charging range from the wireless charging device, the wireless charging device automatically charges the electric wheelchair.

16. The ranging sensor of claim 15, wherein the first sensor is as follows:
the first sensor is navigation device adopting inertial navigation positioning technology, wherein the navigation device includes gyroscope device and wireless sensor; or
the first sensor is camera system adopting simultaneous localization and mapping technology, wherein the camera system includes camera and wireless sensor; or
the first sensor is magnetic sensor adopting geomagnetic positioning technology; or
the first sensor is telephone receiver and transmitter adopting telephone signal network positioning technology.
